(19) United States
(12) Patent Application Publication
(10) Pub. No.: US 2007/0230844 A1
(43) Pub. Date: Oct. 4, 2007

(54) COMBINATION CYLINDRICAL AND SPHERICAL JOINT

(76) Inventors: Jeremy King, Duncan, SC (US); Casimir Krajewski, Rochester Hills, MI (US); James L. Luttinen, Brighton, MI (US); Joseph S. Fedullo, Harrison Township, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/696,002

(22) Filed: Apr. 3, 2007

Related U.S. Application Data
(60) Provisional application No. 60/788,997, filed on Apr. 4, 2006.

(51) Int. Cl. F16C 23/04

(52) U.S. Cl. 384/192

(57) ABSTRACT

Disclosed is a combination joint that affords axial, rotational and tilt movement. The joint includes an inner sleeve having an outer surface with a bearing race adjacent to and in contact with the outer surface of the inner sleeve. The inner sleeve can slide within the bearing race along an inner sleeve axis. The inner sleeve, and optionally the bearing race, can also rotate about the inner sleeve axis. A housing having an inner surface that generally matches an outer surface of the bearing race is also included. An end ring that is located at least partially within the housing and has an inner surface that generally matches the outer surface of the bearing race can also be included. The end ring and the housing afford the bearing race and the inner sleeve to tilt about a housing axis. In this manner, a combination joint capable of axial, rotational and tilt movement is provided.

### CROSS-REFERENCE TO RELATED APPLICATIONS

This application claims priority of U.S. Provisional Patent Application Ser. No. 60/788,997 filed Apr. 4, 2006, which is incorporated herein by reference.

### FIELD OF THE INVENTION

This invention relates generally to a mechanical joint. More specifically, the invention relates to a combination joint for axial, rotational, and tilt movement.

### BACKGROUND OF THE INVENTION

The use of rotating and/or flexible joints is common. For example, ball joints contain spherical bearings that afford for the rotation of a shaft about an axis. A Heim joint uses a ball swivel with an opening through which a bolt or other attaching hardware can pass, with a threaded shaft attached. The ball swivel allows for an inserted bolt or other attaching hardware to swivel within the joint while the threaded shaft remains attached to a fixed base. A rag joint typically includes a piece of rubber that is bolted or riveted to flanges mounted on the ends of two different shafts and provides a small amount of flex within a few degrees of the same plane as the two shafts. In addition, a universal joint, also known as a U joint, Cardan joint or Hooke's joint, is a joint in a rigid rod that allows the rod to “bend” in any direction. The universal joint typically includes a pair of ordinary hinges located close together but oriented at ninety degrees relative to one another.

Each of these joints have advantageous properties and characteristics which allow for their use. However, these joints do not provide the three degrees of freedom of axial movement, rotation and tilting. Therefore, there is a need for a combination joint which provides axial movement, rotation and tilting.

### SUMMARY OF THE INVENTION

Disclosed is a combination joint that affords axial, rotational and tilt movement. The joint includes an inner sleeve having an outer surface with a bearing race adjacent to and in contact with the outer surface of the inner sleeve. The inner sleeve can slide within the bearing race along an inner sleeve axis. The inner sleeve, and optionally the bearing race, can also rotate about the inner sleeve axis. A housing having an inner surface that generally matches an outer surface of the bearing race is also included. An end ring that is located at least partially within the housing and has an inner surface that generally matches the outer surface of the bearing race can also be included. The end ring and the housing afford the bearing race and the inner sleeve to tilt about a housing axis. In this manner, a combination joint capable of axial, rotational and tilt movement is provided.

### BRIEF DESCRIPTION OF THE DRAWINGS

FIG. 1 is a cross-sectional side view of one embodiment of the present invention;

FIG. 2 is a another cross-sectional side view of the embodiment shown in FIG. 1;

FIG. 3 is an exploded perspective view of the embodiment shown in FIG. 1; and

FIG. 4 is a cross-sectional view of another embodiment of the present invention.

### DETAILED DESCRIPTION OF THE PREFERRED EMBODIMENTS

The present invention comprises a combination joint capable of axial, rotational and tilt movement. As such, the present invention has utility as a combination joint for use in a machine. The combination joint of the present invention can include an inner sleeve, a bearing race, a housing and an end ring. The inner sleeve fits within the bearing race and is afforded axial movement therein. The bearing race with the inner sleeve therein fits within a housing and end ring such that the inner sleeve and/or bearing race can rotate about an inner sleeve axis and tilt about a housing axis.

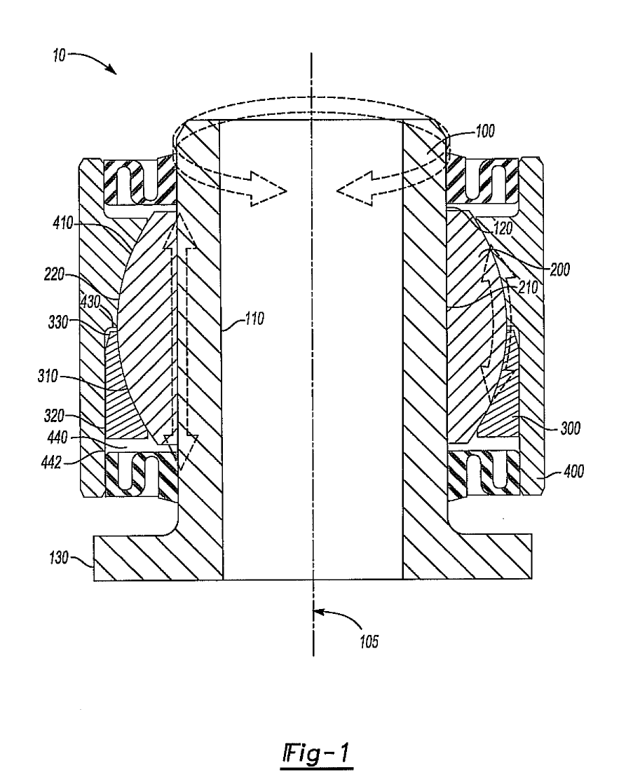

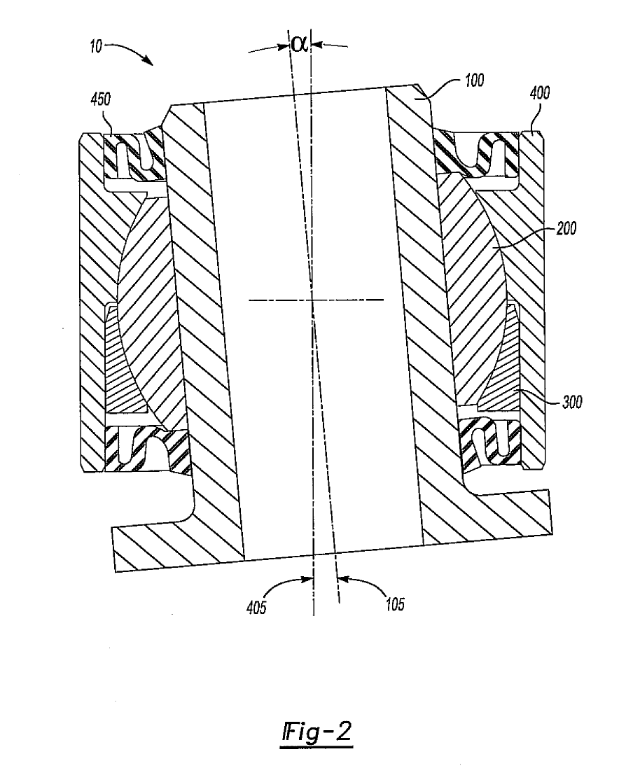

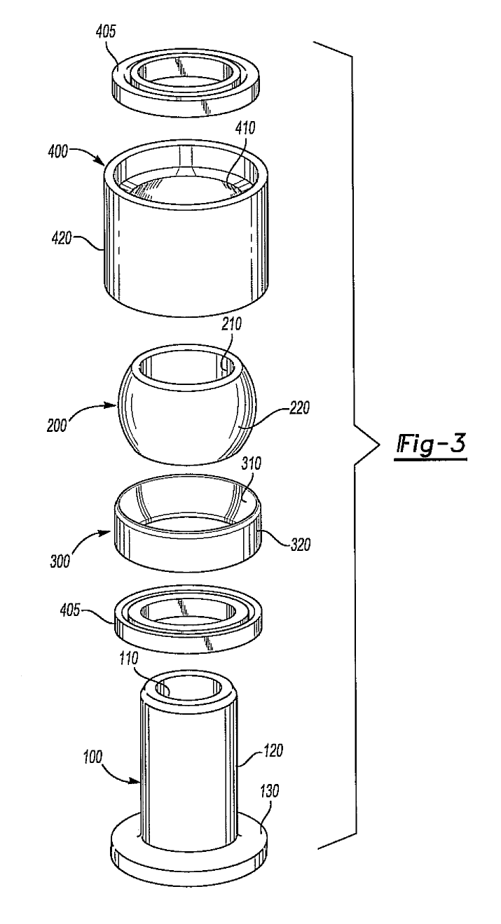

Referring now to FIGS. 1-3, there is shown one embodiment of the combination joint at reference numeral 10. The combination joint 10 of FIG. 1 includes an inner sleeve 100, a bearing race 200, an end ring 300 and a housing 400. The inner sleeve 100 is a generally cylindrical shaped sleeve having an inner surface 110 and an outer surface 120. The inner sleeve 100 optionally includes a flange 130 attached to an end of the sleeve 100. The inner sleeve 100 affords for the insertion of a rod, bolt and the like at least partially within and possibly through said sleeve 100. Adjacent to the inner sleeve 100 is the bearing race 200 with an inner surface 210 that generally matches the outer surface 120 of the inner sleeve 100. The term “generally matches” is defined for purposes of the present invention as being of such a shape and/or dimension that affords one component to be fit against, into and/or onto a second component with a tolerance(s) that affords proper and accepted engineering operation of a mechanical joint for use in a motor vehicle. With respect to the inner sleeve 100 and the bearing race 200, tile present invention affords for the slidable movement of the inner sleeve 100 within the bearing race 200 along an inner sleeve axis 105. The bearing race 200 can also include an outer surface 220 with a convex radius.

Adjacent to the outer surface 220 of the bearing race 200 is a housing 400. The housing 400 has an inner surface 410 which generally matches the outer surface 220 of the bearing race 200. In one instance the inner surface 410 has a concave radius which generally matches the convex radius of the outer surface 220. The housing 400 also includes an outer surface 420 which can be cylindrical in shape. In the alternative, the outer surface 420 is not cylindrical in shape.

The housing 400 has a cavity region 440 wherein an end ring 300 can be placed. The end ring 300 has an inner surface 310 which also generally matches the outer surface 220 of the bearing race 200 and an outer surface 320 that generally matches an inner surface 442 of a cavity region 440. In one instance, the inner surface 310 has a concave radius which generally matches the convex radius of the outer surface 220. The cavity region 440 also includes an abutment surface 430 that an inner end 330 of the end ring 300 can abut up to. In the alternative, a space can be provided between the inlet end 330 and the abutment surface 430. In this manner, the torque require to rotate and/or tilt the inner sleeve and/or bearing race can be adjusted by varying the distance between the inlet end 330 and the abutment surface 430.

As stated above, axial movement along axis 105 by the inner sleeve 100 within the bearing race 200 is afforded. In addition, it is provided for within the present invention that the inner sleeve 100 can rotate about the axis 105 independent of the bearing race 200 rotating in a like manner such that while the inner sleeve 100 can rotate about the axis 105, the bearing race 200 does not rotate at all. In the alternative, the inner sleeve 100 can rotate about the axis 105 dependent on the rotation of the bearing race 200, although said sleeve 100 may or may not rotate at the same rate as bearing race 200. The inner sleeve 100, bearing race 200, end ring 300 and housing 400 also affords for the inner sleeve 100 and bearing race 200 to tilt relative to a housing axis 405 up to an angle α.

In one embodiment of the present invention the inner sleeve 200 can slide along the inner sleeve axis 105 up to 10 millimeters (mm) within the bearing race 200. In a different embodiment of the present invention, the inner sleeve 100 can slide up to 5 mm within the bearing race 200. Also, in one instance the inner sleeve 100 and the bearing race 200 can tilt relative the housing axis 405 (α) up to 5°. In another instance, the inner sleeve 100 and the bearing race 200 can tilt up to 2° relative the housing axis 405. It is appreciated that the inner sleeve 100 and/or bearing race 200 can rotate up to 360° about the inner sleeve axis 105.

The inner sleeve 100, bearing race 200, end ring 300 and housing 400 can be made from any rigid material known to those skilled in the art, illustratively including metals, alloys, ceramics and plastics. In particular, the inner sleeve 100, end ring 300 and housing 400 can be made from a steel alloy. In addition, the bearing race 200 can be made from a high strength plastic.

Although not shown in the figures, the bearing race can include surface indentations on the inner surface 210 and/or the outer surface 220. The indentations can include channels, dimples and combinations thereof within the surfaces. In addition, lubricant can be placed within and/or in contact with the surface indentations in order to afford lubrication of the combination joint. Although not shown in the figures, a lubricant replenishment fitting can also be included with the housing 400 in order to afford lubrication of the combination 10 as known to those skilled in the art.

The combination joint 10 can optionally include one or more seals 450 which afford for the protection of the inner sleeve 100, bearing race 200 and end ring 300 from exposure to dirt, debris, water and the like. In addition, the seals 450 afford for the prevention of lubricant from escaping the combination joint 10. The seals 450 can be made of any material known to those skilled in the art illustratively including an elastomer.

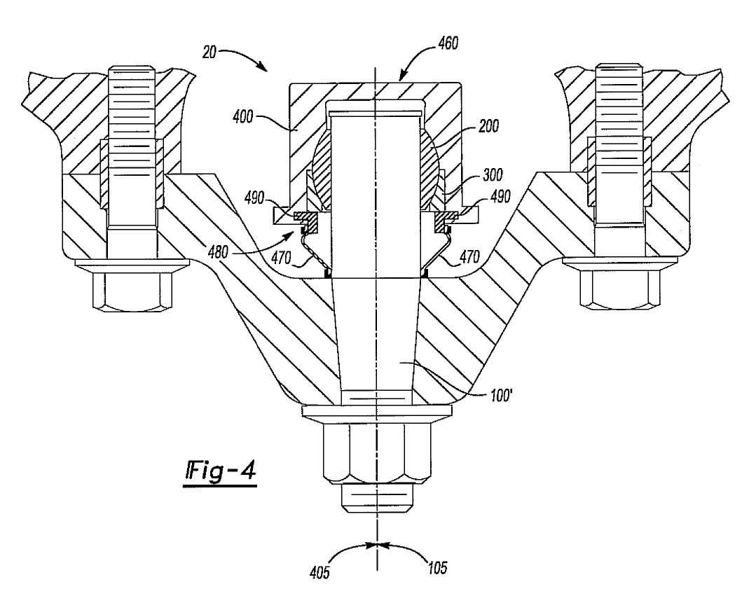

A different embodiment shown generally at 20 is illustrated in FIG. 4 wherein like reference numerals correspond to like items in FIGS. 1-3. The combination joint 20 also affords for axial, rotational and tilt movement, but has a rod 100′ inserted within the bearing race 200 instead of an inner sleeve 100. Similiar to the embodiment shown in FIGS. 1-3, the combination joint 20 includes an end ring 300 and a housing 400. In contrast to the combination joint 10, the combination joint 20 uses the rod 100′ as the inner sleeve 100. In addition, a seal 450 is not present at an upper end 460 of the housing 400, and said seal 450 is replaced by a more traditional boot-type seal 470 at a lower end 480. A rolled ring 490 can also be included with the present embodiment wherein said ring 490 affords placement and securement of the end ring 300.

Similar to the embodiments shown and described in FIGS. 1-3, the rod 100′ is afforded axial movement along the axis 105 within the bearing race 200. In addition, the rod 100′ and bearing race 200 can rotate about the 100′ axis within the housing 400 and tilt relative to the housing axis 405. In this manner, a combination joint which affords axial, rotational and tilt movement is provided,

The foregoing drawings, discussion and description are illustrative of specific embodiments of the present invention, but they are not meant to be limitations upon the practice thereof. Numerous modifications and variations of the invention will be readily apparent to those of skill in the art in view of the teaching presented herein. It is the following claims, including all equivalents, which define the scope of the invention.

I claim:

1. A combination joint for axial, rotational and tilt movement comprising:
an inner sleeve having an outer surface and an inner sleeve axis;
a bearing race adjacent to and in contact with said outer surface of said inner sleeve, said inner sleeve slidable within said bearing race along said inner sleeve axis, and
said inner sleeve and said bearing race operable to rotate about said inner sleeve axis;
a housing having a housing axis and an inner surface generally matching an outer surface of said bearing race;
an end ring at least partially within said housing and having an inner surface generally matching said bearing race outer surface;
said end ring and said housing operable to allow said bearing race and said inner sleeve to tilt about said housing axis, for the purpose of providing a combination joint capable of axial, rotational and tilt movement.

2. The invention of claim 1, wherein said inner sleeve can slide up to 10 mm within said bearing race.

3. The invention of claim 1, wherein said inner sleeve can slide up to 5 mm within said bearing race.

4. The invention of claim 1, wherein said inner sleeve rotates about said inner sleeve axis independently of said bearing race.

5. The invention of claim 1, wherein said inner sleeve and said bearing race tilts up to 5° about said housing axis.

6. The invention of claim 1, wherein said inner sleeve and said bearing race tilts up to 2° about said housing axis.

7. The invention of claim 1, wherein said housing is made from an alloy.

8. The invention of claim 7, wherein said alloy is a steel alloy.

9. The invention of claim 1, wherein said bearing race is made from a plastic.

10. The invention of claim 9, wherein said plastic is a high strength plastic.

11. The invention of claim 1, wherein said inner housing is made from an alloy.

12. The invention of claim 11, wherein said alloy is a steel alloy.

13. The invention of claim 1, wherein said bearing race inner surface and outer surface have indentations, said indentations selected from the group consisting of channels, dimples and combinations thereof.

14. The invention of claim 1, wherein said housing has an end ring abutment surface and said end ring has an inlet end adjacent said end ring abutment surface.

15. The invention of claim 14, wherein said inlet end of said end ring is spaced apart from said abutment surface of said housing.

16. A combination joint for axial, rotational and tilt movement comprising:
an inner sleeve having an outer surface and a first axis;
a bearing race adjacent to and in contact with said outer surface of said inner sleeve, said bearing race having an outer surface with a convex radius,
said inner sleeve slidable within said bearing race along said first axis, and
said inner sleeve and said bearing race operable to rotate about said first axis dependently or independently of each other;
a housing having a second axis and an inner surface with a concave radius matching the outer surface convex radius of said bearing race, said housing inner surface adjacent to and in contact with at least part of said bearing race outer surface;
an end ring having an inner surface with a concave radius matching the outer surface convex radius of said bearing race, said end ring inner surface adjacent to and in contact with at least part of said bearing race outer surface;
said end ring and said housing forming a bearing race seat operable for said bearing race with said inner sleeve in contact therewith to be seated and allow said bearing race with said inner sleeve in contact therewith to tilt about said second axis, for the purpose of providing a combination joint capable of axial, rotational and tilt movement.

17. The invention of claim 16, wherein said inner sleeve can slide up to 10 mm within said bearing race.

18. The invention of claim 16, wherein said inner sleeve can slide up to 5 mm within said bearing race.

19. The invention of claim 16, wherein said inner sleeve and said bearing race tilts up to 5° about said housing axis.

20. The invention of claim 16, wherein said inner sleeve and said bearing race tilts up to 2° about said housing axis.
